(19) United States
(12) Patent Application Publication
(10) Pub. No.: US 2024/0229216 A1
(43) Pub. Date: Jul. 11, 2024

(54) METHOD FOR MANUFACTURING THERMAL SPRAY COATING AND YTTRIUM-BASED THERMAL SPRAY COATING MANUFACTURED BY THE SAME

(71) Applicant: KoMiCo Ltd., Anseong-si (KR)

(72) Inventors: Dong Hun Jung, Anseong-si (KR); Dae Sung Kim, Anseong-si (KR)

(21) Appl. No.: 18/535,020

(22) Filed: Dec. 11, 2023

(30) Foreign Application Priority Data
Jan. 10, 2023 (KR) 10-2023-0003626

(51) Int. Cl. C23C 4/10; C23C 4/134

(52) U.S. Cl. CPC C23C 4/10; C23C 4/134

(57) ABSTRACT

A method for manufacturing an yttrium-based thermal spray coating is disclosed. The method includes spraying yttrium-based granular powder containing a mixture of yttrium compound powder and silica (SiO₂) powder by an atmospheric plasma spraying process to form the yttrium-based thermal spray coating on a base member, in which the yttrium compound is any one selected from Y₂O₃, YOF, YF₃, Y₄Al₂O₉, Y₃Al₅O₁₂ and YAlO₃, the silica (SiO₂) occupies 0.1 to 30 wt %, and the yttrium-based thermal spray coating has a value ‘L’ of 80.0 or greater as a colorimetric measurement value under a plasma exposure condition.

### TECHNICAL FIELD

The present invention relates to method for manufacturing a thermal spray coating having a white or high purity color using yttrium-based granular powder for spray coating containing a silica component.

### BACKGROUND ART

In a semiconductor device manufacturing process, the importance of a plasma dry etching process is increasing for micro machining for high integration of circuits on substrates such as silicon wafers.

In this environment, a technique for manufacturing a chamber member with a material with excellent plasma resistance, a technique for forming a coating on the surface of the member with a material with excellent plasma resistance, and the like have been proposed in order to increase the lifespan of the member.

In particular, a technique of coating the surface of a base member with various materials to provide new functionality has been used in various fields for a long time. As such a surface coating technique, for example, a thermal spraying technique for forming a thermal spray coating by spraying thermal spray particles made of a material such as ceramics in a softened or melted state by combustion or electric energy onto the surface of a base member has been proposed.

Generally, the thermal spray coating is performed by heating and melting fine powder and spraying the melted powder toward the surface of a base member. As the sprayed melted powder is rapidly cooled, the melted powder solidifies and is mainly deposited on the surface through a mechanical bonding force.

As such thermal spray coating, plasma spray coating, in which the powder is melted by high-temperature plasma flame, is essentially used in coating ceramics and metal such as tungsten or molybdenum with a high melting point. The thermal spray coating is advantageous in producing highly functional materials having characteristics of wear resistance, corrosion resistance, heat resistance and thermal barrier, carbide, oxidation resistance, insulation, friction characteristics, heat dissipation, and biological function radiation resistance by utilizing material characteristics of the base member, and has an advantage of coating a large area of an object in a shorter time compared with other coating methods such as chemical vapor deposition or physical vapor deposition.

Further, in the field of manufacturing semiconductor devices or the like, micro-machining is generally performed on the surface of a semiconductor substrate by dry etching using plasma of halogen-based gas such as fluorine, chlorine, or bromine. In addition, after the dry etching, the semiconductor substrate is taken out of a chamber (vacuum container), and then, the inside of the chamber is cleansed using oxygen gas plasma. Here, there is a concern that a member exposed to highly reactive oxygen gas plasma or halogen gas plasma inside the chamber may be corroded. In a case where the corroded portion falls off from the member in the form of particles, these particles may attach to the semiconductor substrate and become foreign substances (hereinafter, referred to as particles) that cause defects in circuits.

Accordingly, conventionally, in semiconductor device manufacturing apparatuses, a thermal spray coating of ceramics having plasma corrosion resistance has been applied to a member exposed to oxygen gas plasma or halogen gas plasma, for the purpose of reducing generation of particles.

Further, the generation of particles may occur by delamination of reaction products that attach to the vacuum chamber and deterioration of the chamber due to use of halogen gas plasma or oxygen gas plasma. Further, according to the present inventors' review, it was found that the number and size of particles generated from the thermal spray coating under the dry etching environment result from the size of a bonding force between the particles forming the thermal spray coating, the presence of non-melted particles, or high porosity.

In particular, as the density inside the ceramic thermal spray coating increases, the degree of adsorption of CFx-based process gas due to defects such as pores in the dry etching process decreases, thereby reducing etching due to plasma ion collision.

In general, coating methods for forming a high-density thermal spray coating include suspension plasma spraying (SPS), aerosol deposition (AD), or physical vapor deposition (PVD). These three methods have disadvantages of a complicated manufacturing method and high manufacturing cost compared with the existing air plasma spray (APS) method.

In the case of the suspension plasma spraying (SPS), a relatively high heat source causes problems such as product deformation due to high process temperature during coating in a semiconductor chamber. Further, the particle size decreases, and a particle flight distance becomes shorter, so that a working distance between the plasma device and the substrate to be coated becomes close to partially limit the process. In addition, since the SPS technique uses a suspension in which water and particles are dispersed, in a case where the same volume is injected, a film formation speed of the coating is low, which results in additional processing time and high manufacturing cost.

Further, the aerosol deposition (AD) and the physical vapor deposition (PVD) have technical limitation in achieving a coating thickness of hundreds of μm, and also, have limitation in coating substrates with complex shapes.

Accordingly, there is a need to develop a technique capable of implementing a high-density thermal spray coating using the existing atmospheric plasma spraying (APS).

In the case of the thermal spray material powder used in the normal APS thermal spraying method, primary particles of several μm are combined to form granular powder of 20 to 40 μm. Here, a method for making the primary powder that forms the thermal spray material powder smaller than 1 μm to increase the density of the thermal spray coating has been proposed. However, in this method, as a specific surface area of the granular powder increases, heat is not uniformly transferred to the primary powder inside the particles, and thus, a film containing a non-melted or re-melted state is formed on the surface or inside of the thermal spray coating, which results in particle generation during the dry etching process.

Further, in a case where secondary particles formed as the granular powder are too small, the granular particles clump together due to electrostatic attraction between the particles, thereby making it difficult to transport the powder in the atmosphere. In addition, even after the transport of the particles, there is a high concern that the particles are not transported to a central frame due to a low particle mass and are dispersed elsewhere.

As a conventional technique, a thermal spray material disclosed in Korean Laid-Open Patent Publication No. 10-2016-0131918 (2016 Nov. 16) includes elemental oxyhalide (RE-OX) containing a rare earth element (RE), oxygen (O), and a halogen element (X) as ingredient elements, in which a molar ratio (X/RE) of the halogen element to the rare earth element is 1.1 or greater, thereby improving plasma resistance and properties such as porosity and hardness.

Further, Korean Laid-Open Patent Publication No. 10-2005-0013968 (2005 Feb. 5) discloses a plasma resistant member containing a silicon element of 100 to 1000 ppm in a yttria coating layer. However, since the yttria coating layer containing the silicon element is a semiconductor ingredient, there is a risk of arcing due to its electrical properties. Further, since the basic color is black, it is difficult to distinguish contaminants in a semiconductor process, and thus, there is a high concern that an unnecessary cleansing process may be added to prevent confusion in cleansing a chamber.

Previous research found that a high-density coating layer have superior plasma resistance properties in the case of the same material. In order to form such a high-density coating layer, there has been proposed a method for performing coating while keeping a separation distance between a base member and a plasma gun close to achieve a fast particle speed and a short particle cooling time, in which the coating is performed by completely melted particles to form a high-density coating.

However, due to the short separation distance, a flying distance of the melted particles becomes short to cause deoxidization due to insufficient oxygen supply, which results in change of color of the coating layer or turning to black in a certain or entire area thereof. Such a coating color different from a desired color may cause problems described below.

Black areas or spots may cause confusion with process contaminants, which results in unnecessary removal of the coating layer during a cleansing process. Here, the color change of the coating layer may change a radiation absorption rate of plasma during an etching process, which causes undesirable changes in process conditions.

Specifically, the black color of the coating layer absorbs radiation, thereby increasing temperature of the coating, which may increase an etching rate. Further, non-uniformity in the color of the coating layer causes a radiation absorption difference, thereby causing a local temperature difference, and accordingly, a thermal expansion difference, which may cause particle generation or delamination due to thermal stress.

In addition, a deoxidized area of the coating layer cannot achieve complete stoichiometry to cause an unstable energy state, thereby causing a local increase in the etching rate.

Meanwhile, by performing a heat treatment process on the coating layer in an oxygen atmosphere, the black color or black spots may return to a white color, but in a case where the base member is made of metal, there is a concern that the base member may be melted. Further, since the heat treatment temperature of ceramic coating is high, it may cause deformation of the base member, and may cause problems such as delamination due to a difference in thermal expansion between the coating and the base member or oxidation of the base member due to heat treatment in an oxygen atmosphere.

As described above, in the related art, in order to overcome the physical property limitations of spraying materials of yttrium oxide or yttrium fluoride, techniques for manufacturing an yttrium-based spray coating with black spots removed have been proposed, but there is still a continuous demand for development of a technique for manufacturing a dense thermal spray coating having a uniform color and improved plasma resistance.

### SUMMARY

### Technical Problem

The present invention has been made in view of the above problems, and an object of the present invention is to provide a method capable of forming a coating layer with low porosity and high hardness by adding silica particles in thermal spray granular powder to increase melting efficiency.

Further, another object of the present invention is to provide a method capable of preventing the problem of black spots or black color under conditions where deoxidization of a thermal spray coating occurs, and uniformly adjusting the color of the thermal spray coating depending on the addition ratio of silica.

### Technical Solution

In accordance with an aspect of the present invention, the above and other objects can be accomplished by the provision of a method for manufacturing an yttrium-based thermal spray coating, including: spraying yttrium-based granular powder containing a mixture of yttrium compound powder and silica (SiO₂) powder by an atmospheric plasma spraying process to form the yttrium-based thermal spray coating on a base member, in which the yttrium compound is any one selected from Y₂O₃, YOF, YF₃, Y₄Al₂O₉, Y₃Al₅O₁₂ and YAlO₃, the silica (SiO₂) occupies 0.1 to 30 wt %, and the yttrium-based thermal spray coating has a value ‘L’ of 80.0 or greater as a colorimetric measurement value under a plasma exposure condition.

Here, the granular powder may be manufactured by mixing the yttrium compound powder with an average diameter of 0.1 to 10 μm and the silica powder with an average diameter of 0.1 to 10 μm.

Further, the atmospheric plasma spraying process may use a plasma gas containing an inert gas flow rate of 30 to 70 NLPM.

Further, the atmospheric plasma spraying process may use a plasma generation output in a range of 20 to 130 kW.

Further, the atmospheric plasma spraying process may use a spray unit placed at a distance of 50 to 400 mm with respect to the base member and a feeder having a feed rate of 10 to 50 g/min.

In accordance with another aspect of the present invention, there is provided an yttrium-based thermal spray coating manufactured by the method for manufacturing the yttrium-based thermal spray coating.

Further, the yttrium-based thermal spray coating may contain 0.01 to 5 at % of silicon (Si).

Further, the yttrium compound may be yttrium oxide (Y₂O₃), and the yttrium oxide may contain a monoclinic form of 1 to 50 wt % as a crystal structure thereof.

Further, the porosity of the yttrium-based thermal spray coating may be less than 2%.

Further, the yttrium-based thermal spray coating may contain less than 0.1 at % of silicon (Si), and the yttrium-based thermal spray coating may have an ‘a’ value of 1 or less and a ‘b’ value of 1 or less as colorimetric measurement values under a plasma exposure condition, and exhibits a white color.

Further, the yttrium-based thermal spray coating may contain silicon (Si) of 0.1 to 1.0 at %, and the yttrium-based thermal spray coating may have an ‘a’ value of 5 or less and a ‘b’ value of 5 or less as colorimetric measurement values under a plasma exposure condition, and exhibits a red color.

Further, the yttrium-based thermal spray coating may contain silicon (Si) of 1.0 to 5.0 at %, and the yttrium-based thermal spray coating may have an ‘a’ value of 1 or less and a ‘b’ value of 10 or less as colorimetric measurement values under a plasma exposure condition, and exhibits a yellow color.

Further, the yttrium-based thermal spray coating may have a main peak value of 29.1° or higher obtained by XRD analysis.

### Effects of the Invention

According to the present invention, it is possible to manufacture a thermal spray coating from yttrium-based thermal spraying powder containing a silica component, capable of suppressing the phenomenon of forming black spots or black color, forming a white thermal spray coating with a uniform color, and preventing problems such as delamination of the thermal spray coating or change in the etching speed due to local heat absorption and temperature change during an etching process.

Further, according to the present invention, it is possible to provide a thermal spray coating with low porosity and excellent hardness, and excellent durability when used as a coating material for members of a semiconductor chamber, to suppress the phenomenon of coating detachment due to etching, thereby improving the yield of semiconductor wafers.

### BRIEF DESCRIPTION OF DRAWINGS

FIG. 1 shows results of X-ray diffraction analysis (XRD) of thermal spray coatings according to Comparative Example 1 and Examples 2, 4, and 6 of the present invention; and

FIG. 2 shows results of photoluminescence (PL) of thermal spray coatings according to Comparative Example 1 and Examples 2, 4, and 6 of the present invention.

### DETAILED DESCRIPTION OF EXEMPLARY EMBODIMENTS

### Best Mode

Unless otherwise defined, all technical and scientific terms used in this specification have the same meanings as commonly understood by those skilled in the art to which the present invention pertains. In general, the nomenclature used herein is well known and commonly used in the art.

Throughout the specification, in a case where an element “includes” a sub-element, this means that the element may further include other sub-elements unless specifically stated to the contrary.

In a semiconductor device manufacturing process, a gate etching device, an insulating film etching device, a resist film etching device, a sputtering device, a CVD device, and the like are used. In a liquid crystal manufacturing process, an etching device for forming a thin film transistor is used. Additionally, these manufacturing devices are provided with a plasma generating mechanism, for example, for high integration through micro-machining.

In the manufacturing processes, halogen-based corrosive gases such as fluorine-based gases or chlorine-based gases are used as processing gases in the above-described devices due to their high reactivity. Examples of the fluorine-based gases include SF₆, CF₄, CHF₃, ClF₃, HF, NF₃, or the like, and examples of the chlorine-based gases include Cl₂, BCl₃, HCl, CCl₄, SiCl₄, or the like. When microwaves or high-frequency waves are applied to an atmosphere into which these gases are introduced, these gases become plasma. Device members exposed to these halogen-based gases or their plasma are required to have very little metallic components other than material components of the members on their surfaces and to have high corrosion resistance.

Accordingly, the present invention provides a method for manufacturing a thermal spray coating having a uniform color and excellent plasma resistance, capable of coating a member used for a plasma etching device.

The method for manufacturing an yttrium-based thermal spray coating, includes spraying yttrium-based granular powder containing a mixture of yttrium compound powder and silica (SiO₂) powder by an atmospheric plasma spraying process to form the yttrium-based thermal spray coating on a base member, in which the yttrium compound is any one selected from Y₂O₃, YOF, YF₃, Y₄Al₂O₉, Y₃Al₅O₁₂ and YAlO₃, the silica (SiO₂) occupies 0.1 to 30 wt %, and the yttrium-based thermal spray coating has a value ‘L’ of 80.0 or greater as a colorimetric measurement value under a plasma exposure condition.

Here, the above-mentioned “plasma exposure conditions” are to expose, using a DC plasma gun, the coating to Ar gas and H gas at a distance of 70 mm from an entrance of a gun nozzle for 5 minutes in plasma with an output of 80 kW, in which the color is determined as color within 30 seconds after the exposure.

The granular powder may be manufactured by mixing the yttrium compound powder with an average diameter of 0.1 to 10 μm and 70 to 99.9% by mass and the silica powder with an average diameter of 0.1 to 10 μm and 0.1 to 30% by mass.

In addition, an average diameter of primary particles of the yttrium compound powder selected from Y₂O₃, YOF, YF₃, Y₄Al₂O₉, Y₃Al₅O₁₂ and YAlO₃ and the silica powder is preferably 0.1 to 30 μm, and more preferably 0.2 to 15 μm.

In a case where the average diameter of the yttrium compound powder and the silica powder is less than about 0.1 μm, it is difficult to control the powders, and thus, it may be difficult to form spherical granular powder and to control physical properties thereof. Further, in a case where the average diameter of the primary particles of the yttrium compound powder and the silica powder exceeds about 30 μm, an average diameter of granular powder formed by mixing the primary particles may become too large, thereby making it difficult to form a uniform thermal spray coating.

Here, the size of the granular powder according to the present invention may be 1 to 50 μm, preferably 5 to 40 μm, and more preferably 10 to 30 μm.

In a case where the size of the yttrium-based granular powder for thermal spraying is less than 1 μm, flowability of the powder during thermal spray coating is low, thereby making it difficult to realize a uniform film. Further, since the powder is oxidized before being delivered to a frame or is not delivered to the center of the frame, it is difficult to meet a droplet flight speed and the quantity of heat for forming a dense film, thereby resulting in formation of a film with high porosity or low hardness. In a case where the average diameter of the yttrium-based granular powder exceeds 50 μm, a specific surface area of the melted granular powder decreases so that complete melting cannot be achieved to cause non-melted portions in the coating film, thereby making it difficult to realize a desired quality of a thermal spray coating.

Since the flowability of the yttrium-based granular powder for thermal spraying acts as an important factor in the quality of the thermal spray coating, it is most desirable to manufacture the powder in a spherical shape. Otherwise, since a necessary amount of powder cannot be delivered to the frame in manufacturing the thermal spray coating, it is difficult to form a desired quality of the coating.

In the present invention, the base member to be coated with the thermal spray coating is not particularly limited. For example, as long as the base member contains a material capable of providing desired resistance by thermal spraying of the above-described thermal spray materials, its material or shape is not particularly limited. As the material used for the base member, for example, it is preferable to use combination of at least one selected from aluminum, nickel, chromium, zinc, alloys thereof, alumina, aluminum nitride, silicon nitride, silicon carbide, and quartz glass that are used to form members for semiconductor device manufacturing apparatuses, or the like.

Such a base member is a member that forms, for example, a semiconductor device manufacturing apparatus, and may be a member exposed to highly reactive oxygen gas plasma or halogen gas plasma.

Before plasma spraying, the surface of the base member is preferably treated in accordance with RECOMMENDED PRACTICE FOR CERAMIC SPRAYED COATINGS specified in JIS H 9302. For example, after removing rust and grease from the surface of the base member, grinding particles such as Al₂O₃ and SiC are sprayed to the surface to roughen the surface, and the base member is pretreated to become a state in which fluoride thermal spray granular powder can easily adhere thereto.

A spray gun in the atmospheric plasma spray coating melts the coating material using plasma flame, and sprays the melted coating material onto the base member. For example, the plasma flame may be formed by dissociating part of plasma gas containing argon gas (Ar), nitrogen gas (N₂), hydrogen gas (H₂), helium gas (He), or the like.

The atmospheric plasma thermal spray coating preferably has, as spraying process variables, a flow rate of inert gas of 20 to 100 NLPM and a flow rate of hydrogen gas of 1 to 50 NLPM, and more preferably, a flow rate of inert gas of 30 to 70 NLPM and a flow rate of hydrogen gas of 5 to 30 NLPM.

In a case where the flow rate of the inert gas is less than 30 NLPM, the output becomes low and the overall thermal capacity becomes low, which reduces the porosity and film formation speed of the thermal spray coating, and in a case where the flow rate of the inert gas is greater than 70 NLPM, the output becomes too high, which causes etching of consumables.

In a case where the flow rate of the hydrogen gas is less than 1 NLPM, the plasma output is too low to ignite, and in a case where the flow rate of the hydrogen gas is greater than 50 NLPM, the turbulence of the plasma gas increases to increase interaction with the surrounding air.

In addition, the atmospheric plasma spray coating preferably has a plasma generation output of 20 to 130 KW, and more preferably, 40 to 110 KW.

In a case where the output is less than 20 KW, the powder may not melt sufficiently, and thus, a coating may not be formed, or non-melted particles may be formed inside the coating, and in a case where the output is greater than 130 KW, large heat energy is supplied, thereby causing delamination of coating.

The plasma spray coating is preferably performed in a state where the spray unit is placed at a distance of 50 to 400 mm from the base member, and more preferably, at a distance of 100 to 200 mm from the base member.

In a case where the distance between the spray unit and the surface of the base member is shorter than approximately 50 mm, the working distance is too close to manufacture a uniform thermal spray coating, and in a case where the distance is longer than 400 mm, the flying distance of the yttrium-based granular powder increases, so that the melted granular powder that reaches the surface is hardened to cause pores within the coating, thereby resulting in a coating with low density.

Here, in a case where the distance between the spray unit and the surface of the base member is 50 to 400 mm, the feeding speed of the feeder transported by the spray unit is preferably 10 to 50 g/min. In a case where the feeding speed of the feeder is greater than 50 g/min, the feeding amount of feeder powder transferred per unit time is too large, and thus, it is difficult to manufacture a uniform thermal spray coating. Further, part of the feeder powder is not completely melted, which results in increase in the porosity of the thermal spray coating. In addition, in a case where the feeding speed of the feeder is less than 10 g/min, the feeding amount is insufficient, and thus, the uniformity of the thermal spray coating is lowered due to pulsation of the thermal spray coating, and the production yield is lowered.

In the plasma spray coating method, the thickness of the yttrium-based spray coating is preferably 50 to 500 μm.

While the conventional yttrium-based thermal spray coating shows a high porosity in the coating layer, in the present invention, the silica component is added as the primary powder to lower the melting point of the yttrium-based compound, thereby making it possible to manufacture a white yttrium-based thermal spray coating with low porosity.

Accordingly, the yttrium-based thermal spray coating manufactured by the above method has a superior porosity level compared with existing thermal spray coatings, to thereby exhibit excellent durability when applied to a semiconductor chamber used in an existing etching process, and to suppress the phenomenon of delamination of coating due to etching gas.

Here, in the yttrium-based thermal spray coating according to the present invention, the silicon element may be partially vaporized during the manufacturing process of the thermal spray coating, and thus, the yttrium-based thermal spray coating contains the silicon element in a range of 0.01 to 5 at %.

In addition, in the yttrium-based thermal spray coating according to the present invention, in a case where the yttrium compound is yttrium oxide (Y₂O₃), the yttrium oxide may include a monoclinic form of 1 to 50 wt % as a crystal structure thereof. In this case, it is predicted that the monoclinic crystal structure of yttrium oxide (Y₂O₃) has the effect of increasing a bonding strength between yttrium oxide particles to thereby contribute to reducing the sizes of pores in the thermal spray coating.

As an example, the yttrium-based thermal spray coating formed by the yttrium-based thermal spray coating manufacturing method may have a porosity of 2.0% or less, preferably 1.5% or less, and more preferably 1% or less.

In addition, the yttrium-based thermal spray coating according to the present invention exhibits a uniform color in an environment exposed to plasma, thereby suppressing generation of particles in the thermal spray coating or delamination of the thermal spray coating due to thermal expansion of the coating layer due to local temperature differences.

As an example, the yttrium-based thermal spray coating according to the present invention may contain the silicon (Si) element of less than 0.1 at %, may have an ‘a’ value of 1 or less and a ‘b’ value of 1 or less, in particular, as colorimetric measurement values under plasma exposure conditions, and in this case, may show a uniform white color.

Further, as an example, the yttrium-based thermal spray coating according to the present invention may contain the silicon (Si) element of 0.1 to 1.0 at %, may have an ‘a’ value of 5 or less and a ‘b’ value of 5 or less, in particular, as colorimetric measurement values under plasma exposure conditions, and in this case, may show a uniform red color.

In addition, as an example, the yttrium-based thermal spray coating according to the present invention may contain the silicon (Si) element of 1.0 to 5.0 at %, may have an ‘a’ value of 1 or less and a ‘b’ value of 10 or less, in particular, as colorimetric measurement values under plasma exposure conditions, and in this case, may show a uniform yellow color.

The above “plasma exposure conditions” are to expose, using a DC plasma gun, the coating to Ar gas and H gas in plasma with an output of 80 KW for 5 minutes at a distance of 70 mm from an entrance of the gun, in which the color is determined as color within 30 seconds after the exposure.

Further, as an example, the yttrium-based thermal spray coating may have a main peak value of 29.1° or greater, respectively obtained by XRD analysis.

Hereinafter, the present invention will be described in more detail through examples. Here, the following examples only illustrate the present invention, and do not limit the present invention.

### Manufacturing Examples 1 to 6

After mixing a binder with yttria powder and silica powder, granulated powder was obtained using a spray dryer, and then, the granulated powder was degreased and sintered to obtain sintered powder. Experimental conditions, such as the size and mixing ratio of the yttria powder and silica powder used in each manufacturing example, are shown in Table 1.

TABLE 1

| | | Size of | Granular | Mixing ratio of |
|---|---|---|---|---|
| | | primary | powder | primary powder |
| | Ingredient | powder (μm) | (μm) | (wt %) |
| Manufacturing | Y₂O₃ | 1 | 25 | 100.0 |
| Example 1 | | | | |
| Manufacturing | Y₂O₃ | 1 | 25 | 99.9 |
| Example 2 | SiO₂ | 1 | | 0.1 |
| Manufacturing | Y₂O₃ | 1 | 25 | 95.0 |
| Example 3 | SiO₂ | 1 | | 5.0 |
| Manufacturing | Y₂O₃ | 1 | 25 | 90.0 |
| Example 4 | SiO₂ | 1 | | 10.0 |
| Manufacturing | Y₂O₃ | 1 | 25 | 65.0 |
| Example 5 | SiO₂ | 1 | | 35.0 |
| Manufacturing | Y₂O₃ | 1 | 25 | 50.0 |
| Example 6 | SiO₂ | 1 | | 50.0 |

### Comparative Examples 1 to 6

The thermal spraying materials and plasma gun prepared in the Manufacturing Examples 1, 2 and 6 were used, argon gas and hydrogen gas were introduced as heat source gases, plasma was generated at a power of 20 kW while moving the thermal spray gun, and the raw material powder was melted using the generated plasma to form a coating on a base member. The thickness of the coating was 100 to 200 μm, and the experimental conditions are shown in Table 2.

TABLE 2

| | | | Feeder | |
|---|---|---|---|---|
| | | Plasma | conditions | |
| | | conditions | Feeding | Separation |
| | | Output | amount | distance |
| | | (kW) | (g/min) | (mm) |
| Comparative | Manufacturing | 20 | 20 | 200 |
| Example 1 | Example 1 | | | |
| Comparative | Manufacturing | 20 | 20 | 150 |
| Example 2 | Example 1 | | | |
| Comparative | Manufacturing | 20 | 20 | 200 |
| Example 3 | Example 2 | | | |
| Comparative | Manufacturing | 20 | 20 | 150 |
| Example 4 | Example 2 | | | |
| Comparative | Manufacturing | 20 | 20 | 200 |
| Example 5 | Example 6 | | | |
| Comparative | Manufacturing | 20 | 20 | 150 |
| Example 6 | Example 6 | | | |

### Examples 1 to 6

The thermal spraying materials and plasma gun prepared in the manufacturing examples 3 to 5 were used, argon gas and hydrogen gas were introduced as heat source gases, plasma was generated at a power of 20 kW while moving the thermal spray gun, and the raw material powder was melted using the generated plasma to form a coating on a base member. The thickness of the coating was 100 to 200 μm, and the experimental conditions are shown in Table 3.

TABLE 3

| | | | Feeder | |
|---|---|---|---|---|
| | | Plasma | conditions | |
| | | conditions | Feeding | Separation |
| | | Output | amount | distance |
| | | (kW) | (g/min) | (mm) |
| Example 1 | Manufacturing | 20 | 20 | 200 |
| | Example 3 | | | |
| Example 2 | Manufacturing | 20 | 20 | 150 |
| | Example 3 | | | |
| Example 3 | Manufacturing | 20 | 20 | 200 |
| | Example 4 | | | |
| Example 4 | Manufacturing | 20 | 20 | 150 |
| | Example 4 | | | |
| Example 5 | Production | 20 | 20 | 200 |
| | example 5 | | | |
| Example 6 | Manufacturing | 20 | 20 | 150 |
| | Example 5 | | | |

### Experimental Example 1: Observation of Thermal Spray Coating

The porosity of each thermal spray coating was measured as follows. That is, the thermal spray coating was cut on a plane perpendicular to the surface of the base member, the obtained cross section was resin-embedded and polished, and then, an image of the cross section was taken using an electron microscope (JEOL, JS-6010). The image was analyzed using image analysis software (MEDIA CYBERNETICS, Image Pro) to determine the area of pores in the cross-sectional image, and the ratio of the area of the pores to the entire cross section was calculated to obtain the porosity of the pores in the cross section of the thermal spray coating, which is shown in Table 4.

The porosity of each thermal spray coating prepared in Comparative Example 1 and Comparative Example 2 was 2.5% or greater, while Examples 1 to 6 all showed porosities of 2.0% or less, which shows that the density of the yttrium-based thermal spray coating according to the present invention has increased compared with that of the conventional thermal spray coating.

TABLE 4

| | Porosity | Hardness | Roughness |
|---|---|---|---|
| | (%) | (Hv0.05) | (Ra, μm) |
| Example 1 | 1.4 | 410 | 4.3 |
| Example 2 | 0.3 | 440 | 3.1 |
| Example 3 | 0.9 | 600 | 4.1 |
| Example 4 | 0.4 | 664 | 3.2 |
| Example 5 | 0.9 | 602 | 3.8 |
| Example 6 | 0.4 | 657 | 3.3 |
| Comparative Example 1 | 3.2 | 410 | 4.8 |
| Comparative Example 2 | 2.5 | 435 | 3.7 |
| Comparative Example 3 | 3.1 | 425 | 4.1 |
| Comparative Example 4 | 2.5 | 445 | 3.5 |
| Comparative Example 5 | 3.2 | 320 | 4.9 |
| Comparative Example 6 | 2.5 | 349 | 4.6 |

### Experimental Example 2: Measurement of Hardness

The “Hardness” section in Table 4 shows the measurement results of the Vickers hardness of each spray coating. The Vickers hardness is a Vickers hardness (Hv0.05) obtained when a test force of 0.05 kgf is applied by a diamond indenter with a diagonal angle of 136° using the micro-vickers hardness testing machine.

As shown in Table 2, it was confirmed that the thermal spray coatings of Examples 1 to 6 exhibited a hardness range similar to that of the thermal spray coatings of Comparative Examples 1 to 6.

### Experimental Example 3: Measurement of Surface Roughness Ra

The surface roughness Ra (Average Roughness) of each coating manufactured in the examples and comparative examples of the present invention was measured, in which the standard was JIS2001, λ_{c} was 0.8, λₛ was 2.5, the number of measurement sections was 5, the moving speed of the measurement tip was 0.5 mm/s, the measurement device was MITUTOYO SJ-201 (surface roughness tester), and the results were shown in Table 4.

### Experimental Example 4: Measurement of XRD

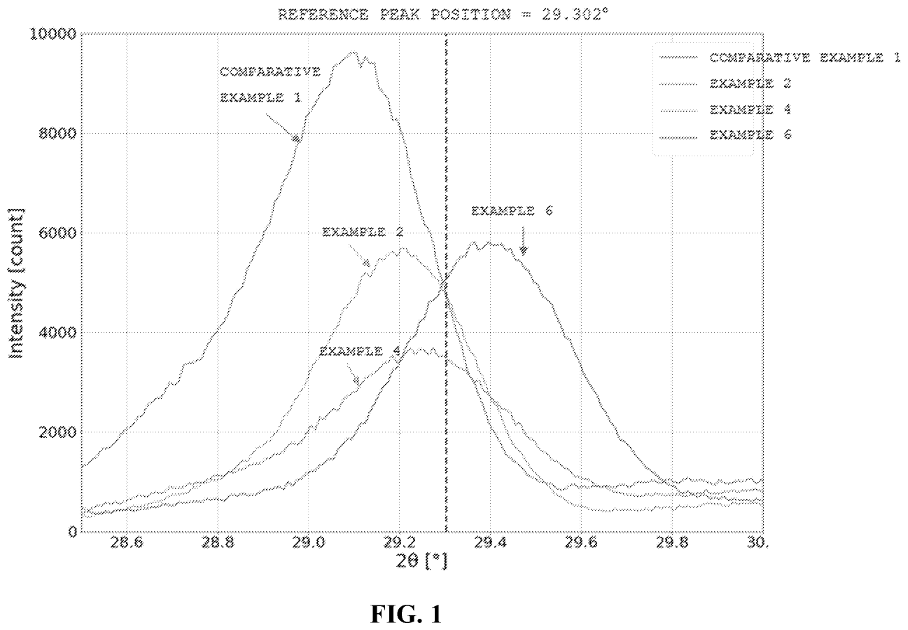

The lattice strain of each coating prepared in the examples and comparative examples of the present invention was measured using the Malvern Panalytical Empyrean X-ray diffractometer (XRD), and the results were shown in FIG. 1 and Table 5.

As shown in Table 5 below, as the content of additives increases during XRD measurement, the position (angle) of a measurement peak moves in the direction of increasing. This is because lattice contraction occurs as Si⁴⁺ having a small atomic radius replaces a Y³⁺ site.

TABLE 5

| | | | | | XRD peak position (°) | | | | XPS |
|---|---|---|---|---|---|---|---|---|---|
| | | | | | | measurement | | | elemental |
| | | | | | | Peak | PL peak | | ratio |
| | Color | | | | | position - | relative | | (at %) |
| | seen with | | | | Measurement | * Standard | intensity | | Si / |
| | naked | Colorimeter (CIE Lab) | | | peak | peak | 380~ | 780~ | (Y + O + |
| | eye | L | a | b | position | position | 440 nm | 840 nm | Si |
| Example 2 | White | 89.46 | −0.40 | −0.67 | 29.197 | −0.105 | 1.36 | 0.12 | 0 |
| Example 4 | Red | 84.39 | 1.1 | 3.34 | 29.231 | −0.071 | 4.08 | 0.36 | 0.5 |
| Example 6 | Yellow | 86.62 | −2.08 | 8.36 | 29.400 | 0.098 | 14.50 | 0.65 | 1.2 |
| Comparative | White | 89.74 | −0.16 | −0.26 | 29.092 | −0.210 | 1.00 | 0.04 | 0 |
| Example 1 | | | | | | | | | |
| Comparative | Black | 39.37 | −0.56 | 0.07 | — | | — | | 0 |
| Example 2 | | | | | | | | | |

### Experimental Example 5: Measurement of PL

As conditions of the PL measurement, a He—Cd laser source, a wavelength of 325 nm, and power of 20 mW were used, and the surface or cross section was polished so that the roughness Ra became 0.1 μm or less.

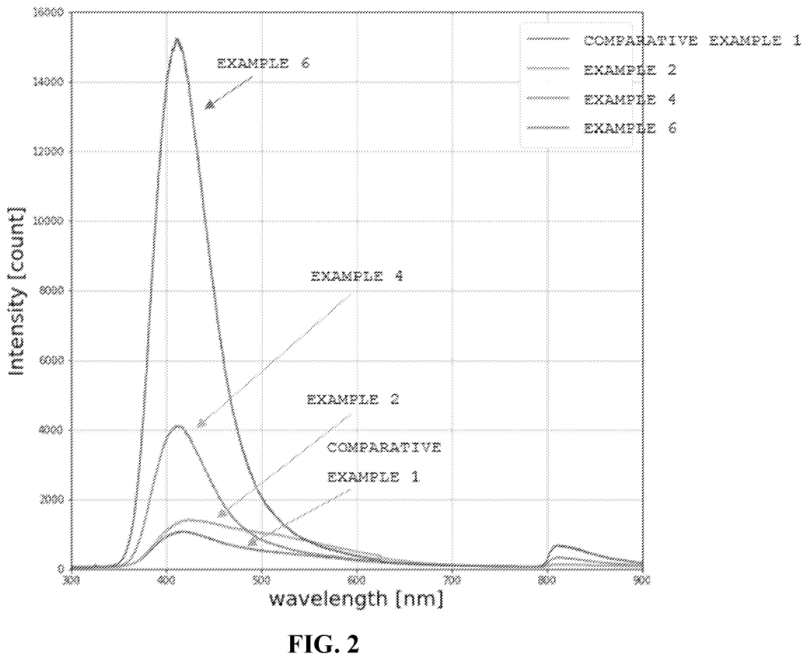

In the PL measurement, a main peak was measured at 380˜440 nm and a sub peak was measured at 780˜840 nm. When the main peak in PL measurement data of Comparative Example 1 was set to 1 as a reference, a relative intensity of the main peak and the sub peak of PL obtained under different conditions is shown in FIG. 2 and Table 5.

### Experimental Example 6: Measurement of XPS

An Si elemental ratio of each coating prepared in the Examples and Comparative Examples of the present invention was measured using the XPS system of THERMO FISHER SCINTIFIC (K-Alpha+), and the results are shown in Table 5 above.

The XPS measurement was performed through depth profiling, etching was performed for more than 400 seconds, and a saturation value was used as a reference.

### Experimental Example 7: Measurement of Color Data (CIELab)

The color data of each coating prepared in the examples and comparative examples of the present invention was measured using the Chroma Meter (CR-310) manufactured by KONICA MINOLTA, and the results are shown in Table 5 above.

Using a DC plasma gun, the coating was exposed to Ar gas and H gas with an output of 80 kW for 5 minutes at a distance of 70 mm from the gun nozzle entrance, and color data was measured with a colorimeter within 30 seconds after the end of exposure.

The above-described embodiments of the present invention are merely exemplary, and it will be clear to those skilled in the art that these embodiments do not limit the scope of the present invention. Accordingly, the substantial scope of the present invention will be defined by the appended claims and their equivalents.

1. A method for manufacturing an yttrium-based thermal spray coating, comprising:
spraying yttrium-based granular powder containing a mixture of yttrium compound powder and silica (SiO₂) powder by an atmospheric plasma spraying process to form the yttrium-based thermal spray coating on a base member,
wherein the yttrium compound is any one selected from Y₂O₃, YOF, YF₃, Y₄Al₂O₉, Y₃Al₅O₁₂ and YAlO₃, the silica (SiO₂) occupies 0.1 to 30 wt %, and the yttrium-based thermal spray coating has a value ‘L’ of 80.0 or greater as a colorimetric measurement value under a plasma exposure condition.

2. The method according to claim 1, wherein the granular powder is manufactured by mixing the yttrium compound powder with an average diameter of 0.1 to 10 μm and the silica powder with an average diameter of 0.1 to 10 μm.

3. The method according to claim 1, wherein the atmospheric plasma spraying process uses a plasma gas containing an inert gas flow rate of 30 to 70 NLPM.

4. The method according to claim 1, wherein the atmospheric plasma spraying process uses a plasma generation output in a range of 20 to 130 kW.

5. The method according to claim 1, wherein the atmospheric plasma spraying process uses a spray unit placed at a distance of 50 to 400 mm with respect to the base material and a feeder having a feed rate of 10 to 50 g/min.

6. An yttrium-based thermal spray coating manufactured by the method for manufacturing the yttrium-based thermal spray coating according to claim 1.

7. The yttrium-based thermal spray coating according to claim 6, wherein the yttrium-based thermal spray coating contains silicon (Si) of 0.01 to 5 at %.

8. The yttrium-based thermal spray coating according to claim 6, wherein the yttrium compound is yttrium oxide (Y₂O₃), and the yttrium oxide contains a monoclinic form of 1 to 50 wt % as a crystal structure thereof.

9. The yttrium-based thermal spray coating according to claim 6, wherein the porosity of the yttrium-based thermal spray coating is less than 2%.

10. The yttrium-based thermal spray coating according to claim 6, wherein the yttrium-based thermal spray coating contains silicon (Si) of less than 0.1 at %, and the yttrium-based thermal spray coating has an ‘a’ value of 1 or less and a ‘b’ value of 1 or less as colorimetric measurement values under a plasma exposure condition, and exhibits a white color.

11. The yttrium-based thermal spray coating according to claim 6, wherein the yttrium-based thermal spray coating contains silicon (Si) of 0.1 to 1.0 at %, and the yttrium-based thermal spray coating has an ‘a’ value of 5 or less and a ‘b’ value of 5 or less as colorimetric measurement values under a plasma exposure condition, and exhibits a red color.

12. The yttrium-based thermal spray coating according to claim 6, wherein the yttrium-based thermal spray coating contains silicon (Si) of 1.0 to 5.0 at %, and the yttrium-based thermal spray coating has an ‘a’ value of 1 or less and a ‘b’ value of 10 or less as colorimetric measurement values under a plasma exposure condition, and exhibits a yellow color.

13. The yttrium-based thermal spray coating according to claim 6, wherein the yttrium-based thermal spray coating has a main peak value of 29.1º or higher obtained by XRD analysis.

14. An yttrium-based thermal spray coating manufactured by the method for manufacturing the yttrium-based thermal spray coating according to claim 2.

15. An yttrium-based thermal spray coating manufactured by the method for manufacturing the yttrium-based thermal spray coating according to claim 3.

16. An yttrium-based thermal spray coating manufactured by the method for manufacturing the yttrium-based thermal spray coating according to claim 4.

17. An yttrium-based thermal spray coating manufactured by the method for manufacturing the yttrium-based thermal spray coating according to claim 5.
